(19) United States
(12) Patent Application Publication
(10) Pub. No.: US 2002/0179589 A1
(43) Pub. Date: Dec. 5, 2002

(54) Lamp annealing device and substrate for a display element

(76) Inventors: Yukihiro Morita, Hirakata-shi (JP); Mikihiko Nishitani, Nara-shi (JP); Munehiro Shibuya, Kofu-shi (JP)

Correspondence Address: Parkhurst & Wendel, 1421 Prince Street Suite 210, Alexandria, VA, 22314-2805, US

(21) Appl. No.: 09/958,203

(22) PCT Filed: Feb. 5, 2001
(86) PCT No.: PCT/JP01/00806

(30) Foreign Application Priority Data
Feb. 8, 2000 (JP) 2000-030047
Feb. 28, 2000 (JP) 2000-050602

(51) Int. Cl. F27D 11/00

(52) U.S. Cl. 219/411; 219/390

(57) ABSTRACT

The present invention relates to an improvement in lamp-annealing devices for annealing a semiconductor film formed on a transparent substrate. In the present invention, a lamp-annealing device is provided with a means for selectively heating a semiconductor film, and a rise in temperature in the substrate during annealing is inhibited. Furthermore, feedback control of the annealing process is carried out based on the light reflected or the light transmitted by the annealed semiconductor film.

### TECHNICAL FIELD

The present invention relates to a lamp-annealing device for use in the manufacture of thin film transistors.

### BACKGROUND ART

Active matrix liquid crystal display panels that use thin film transistors as pixel switching elements are widely used, for example in digital still cameras, digital video cameras, car navigation systems, and notebook-type personal computers.

Amorphous silicon has conventionally been used for the semiconductor layer in thin film transistors, but recently there has been vigorous development of thin film transistors with polycrystalline silicon as the semiconductor layer, which has a significantly greater carrier mobility than amorphous silicon in particular. By using polycrystalline silicon thin film transistors for the pixel switching elements in liquid crystal panels, it has become possible to form not only the transistors but also the driving circuits for driving those transistors on the glass substrate. However, in thin film transistors formed on glass substrates, the softening point of the glass substrate is low at approximately 600° C., and thus they cannot be annealed at elevated temperatures at or above 1000° C. to remove activation and doping damage, such as in the case of MOS transistors formed on silicon substrates. Because insufficient removal of activation and doping damage results in the deterioration of transistor performance and reliability, it is necessary to anneal at the highest temperature possible. The conventional approach has been to conduct furnace annealing over extended periods of time at a relatively low temperature of about 600° C. With furnace anneals, however, because glass substrates were subject to long term exposure to a temperature atmosphere close to the softening point of the glass, the glass substrate underwent shape changes such as distortion or expansion and contraction, and fine processing was complicated. Moreover, due to the glass substrate softening during the annealing, impurities diffused from the glass substrate into the polycrystalline silicon film via the undercoat insulating film, and thus it was difficult to obtain thin film transistors with excellent performance and reliability.

In order to solve these problems, recently anneals have been performed by optical heating for short periods of time using a lamp. A lamp anneal is a process that uses halogen lamps or UV lamps to heat a semiconductor film for a short period of time, thus enabling the semiconductor film to be instantaneously heated to elevated temperatures in excess of 600° C. while hardly heating the substrate.

With lamp anneals, however, the temperature profile is determined by the optical absorption properties and thickness of the semiconductor film, and thus variations in the doping conditions of the impurities or variations in the thickness of the semiconductor film directly affect the properties of thin film transistors. From the fact that in the substrate of an active matrix liquid crystal display panel all of the numerous switching elements formed on the substrate are expected to operate properly, it is necessary to reliably anneal the entire semiconductor film formed on the substrate.

The temperature of a glass substrate increases to a certain extent by the substrate absorbs light projected from a heating light source, such as a halogen lamp or UV lamp, and heat is transferred from the semiconductor film. Overheating causes the substrate to expand and contract or to warp, and complicates fine processing of the semiconductor film and the like during later processing. Consequently, there is a need for annealing the semiconductor film formed on a substrate while suppressing a temperature increase of the substrate.

### DISCLOSURE OF THE INVENTION

An object of the present invention is to provide a lamp-annealing device with little variations in performance of a semiconductor film that is obtained on the same substrate or between substrates. Another object of the present invention is to provide a lamp-annealing device which can prevent shape changes in the substrate and can also reliably activate the semiconductor film.

The lamp-annealing device of the present invention is for annealing a semiconductor film that has been formed on a transparent substrate, and the lamp-annealing device includes:

a light projection means for projecting light for heating toward the transparent substrate; and

a selective heating means disposed between the transparent substrate and the light projection means for selectively heating certain regions of the transparent substrate.

The lamp-annealing device of the present invention is provided with a means for selectively heating certain regions on the transparent substrate, for example, regions on which the semiconductor film to be annealed is formed, or only the semiconductor film.

In a preferred embodiment of the present invention, a light-shielding mask is used as the selective heating means. With the use of the light-shielding mask, light for annealing is irradiated on only regions of a substrate on which a semiconductor film is formed, for example. By avoiding the irradiation of light on unnecessary regions, unnecessary temperature increases of the substrate are suppressed. When the light-shielding mask is used, a region greater than the aperture pattern of the light-shielding mask is irradiated and heated due to diffraction of light. That is, as shown in FIG. 12, the light indicated by the arrow in the drawing is diffused after passing through the aperture portions of a light-shielding mask 3 with aperture portions of a width “D”, and irradiated onto a region of a glass substrate 1 of a width indicated by the “x” in the drawing. To effectively heat a plurality of semiconductor films disposed closely spaced on a substrate, such as a liquid crystal panel, it is preferable that the width of the region heated by diffracted light is smaller than the spacing between the semiconductor films that are to be heated. Here, the relation between the wavelength of the light (λ), the angle of diffraction (θ), and the width of the aperture portions (D) is represented by the following equation:

sin θ=1.22×θ/D.

Under the condition of D>>θ, the width “x” can be approximated with the formula below, which includes the spacing “Δ” between the substrate 1 and the light-shielding mask 3, and the width “D” of the aperture portions.

x˜Δ×1.22×λ/D

Diffraction is dependant on the width “D” of the aperture portion pattern and the spacing “Δ” between the transparent substrate and the light-shielding mask, and thus these should be set to appropriate values, for example, the values established by the formula below.

D+2x<(pitch of the pixels)

Here, diffraction increases when the aperture portion pattern of the mask 3 is smaller than the pattern of the region to be heated. Regions irradiated with diffracted light are more difficult to heat than regions irradiated with direct light, and thus to effectively heat the semiconductor films it is preferable that “x” is decreased and “D” increased.

When the spacing “Δ” between the substrate 1 and the light-shielding mask 3 is decreased, the diffraction of light decreases. However, when bends, vibrations, or the like in the mask 3 are considered, that spacing “Δ” is, for practical use, at least 0.1 mm. If the spacing “Δ” is decreased, the width “x” decreases, and thus an even more precise aperture portion pattern can be used. However, if the width “D” decreases, the width “x” increases. When the pitch between semiconductors is set to 50 μm, which is the standard pitch in liquid crystal panels, the width “D” of the aperture portions from the above formulas is at least 5 μm. When the width “D” of the aperture portions is equal to or greater than the width of the semiconductor films that are to be annealed, then direct light is irradiated on unnecessary regions. In practice, the maximum value of “D” is 100 μm. If the width “D” is increased, the width “x” decreases, so it is preferable that the spacing “Δ” is not larger than 10 mm.

In another preferred embodiment of the present invention, an optical filter that only transmits certain wavelength components from the light projected from the light projection means is used as the selective heating means. For example, by eliminating light of a wavelength range that is absorbed by the substrate, unnecessary temperature increases of the substrate are suppressed, and the semiconductor film is effectively and selectively heated.

The glass substrate, as shown in FIG. 11a, has an extremely high absorption rate of light with a wavelength below 350 nm corresponding to that optical band gap. Additionally, as shown in FIG. 11b, the absorption rate of light with a wavelength over 2.5 μm is high. Consequently, it is desirable that these wavelength components, in which the absorption rate of the glass substrate is high, are removed.

For example, for the optical filter a low pass filter may be used in which the shortest wavelength blocked is 2.5 μm or greater. Light of a wavelength over 700 nm heats the glass substrate, metallic film, and the like, yet on the other hand, that light is hardly absorbed by the semiconductor film. Consequently, it is even more preferable to use a low pass filter in which the shortest wavelength blocked is 700 nm or greater.

In order to prevent heat absorption by the transparent substrate corresponding to the optical band gap, a high pass filter may be used in which the longest wavelengths blocked is at most 350 nm. Thus, light of a wavelength that raises the energy states of the material of which the transparent substrate is composed is blocked.

It is even more effective to use a band pass filter that passes light of a wavelength range of 350 nm to 2.5 μm, or preferably, that passes light of a wavelength range of 350 to 700 mm, in which absorption by polycrystalline silicon films is high.

When a substrate made of the same material as the transparent substrate, for example the same transparent substrate before a semiconductor film or metallic wiring are formed on its surface, is used for the optical filter, then the semiconductor film can be even more easily and effectively heated, because most of the wavelength components of the lamp light that heat the transparent substrate are absorbed by the substrate, which acts as a filter, before the lamp light reaches the transparent substrate on which the semiconductor film that is to be annealed is formed.

For the selective heating means, it is even more effective to use the aforementioned light-shielding mask and the optical filter in combination. That is to say, using the light-shielding mask, the desired wavelength range components from the light irradiated by the light projection means that have passed through the optical filter are irradiated only onto desired regions.

In a further preferred embodiment of the present invention, the light projection means is disposed on a surface of the transparent substrate on which the semiconductor film is formed and also on the surface of the opposite side so as to face each other, and the selective heating means is disposed between one side, for example the surface of the transparent substrate on which the semiconductor film is formed, and the light projection means disposed in opposition to that surface. The light projection means on the side of the selective heating means projects light for annealing toward the transparent substrate, and the light projection means on the other side projects lamp light including components of a wavelength range absorbed by the substrate over the entire substrate when the anneal begins, in order to preliminarily heat the transparent substrate.

It is also possible to dispose the selective heating means on both sides of the transparent substrate and to heat the semiconductor film from both sides. For example, after the aforementioned preliminary heating, the selective heating means, such as the light-shielding mask, is used to selectively heat the semiconductor film from both sides. Heating the semiconductor thin film from both sides allows for fast and high-temperature processing to be carried out uniformly.

In a further preferred embodiment of the present invention, a displacement means for changing the relative position of the light projection means and the transparent substrate is further provided. For example, a region irradiated with light from the light projection means is smaller than the substrate or the regions on which the semiconductor film to be annealed is formed, and the displacement means continually or intermittently changes the relative position of the light projection means and the transparent substrate such that light from the light projection means is irradiated over the entire surface of the substrate or the entire region on which the semiconductor film is formed. Providing a displacement means makes it possible to heat the desired region even when using large substrates. Furthermore, because the region irradiated with light from the light projection means is allowed to be only a portion of the substrate, the energy consumption by the light projection means, which requires significant output, can be reduced. The displacement means shifts either the substrate or the light projection means with the relative position of the substrate and the selective heating means fixed, for example. Here, when the relative position of the substrate and the selective heating means is altered, the change in the diffraction and intensity of the light alters the annealing conditions, and thus it is preferable to fix the substrate or the like, and shift the light projection means.

In a further preferred embodiment of the present invention, a cooling unit for inhibiting a rise in the temperature of the selective heating means and deterioration resulting therefrom, is further provided.

The aforementioned lamp-annealing device is used in the manufacture of polycrystalline silicon thin film transistors. For example, the annealing process activates impurities injected into the polycrystalline silicon film. According to the present invention, the polycrystalline silicon film can be selectively heated while a rise in the temperature of the glass substrate is suppressed. More specifically, the temperature of the glass substrate can be kept lower than its softening point, approximately 600° C., while the polycrystalline silicon film is heated to about 800° C. Thus, the polycrystalline silicon film is sufficiently activated and damage generated by the injection of impurities can be completely eliminated.

Lamp anneals are conducted in an atmosphere including, for example, nitrogen hydrogen compounds, nitrogen oxide compounds, or a mixture thereof. Polycrystalline silicon heated to about 800° C. reacts with the atmospheric gas and is oxynitridated. By undergoing oxynitridation, an interface with few interface states is formed between the polycrystalline silicon film and the oxide film formed thereon as an insulating layer. Furthermore, because a nitrogen rich region is formed near the interface of the semiconductor oxide film, interface stress caused by a difference in the lattice constant is also relieved.

Moreover, when the aforementioned lamp anneal is performed in an atmosphere that includes oxygen or ozone, the polycrystalline silicon film heated to about 800° C. reacts with the oxygen or ozone and is oxidized, thereby obtaining a semiconductor/oxide film interface of high quality.

Another lamp-annealing device of the present invention for annealing a semiconductor film formed on a substrate includes:

a light projection means for projecting light toward a transparent substrate for heating a semiconductor film formed thereon;

a light measurement means for measuring light of a certain wavelength that has passed through the semiconductor film and the transparent substrate or been reflected by the semiconductor film;

a crystal evaluation means for evaluating the crystallinity of the semiconductor film based on the measurement results obtained by the light measurement means; and

a light irradiation control means for controlling the processing conditions of the semiconductor film based on the evaluation results from the crystal evaluation means.

This lamp-annealing device focuses on the conspicuous change in the reflectivity and the transmissivity of certain wavelength ranges in the process of crystallizing the semiconductor film from an amorphous state by lamp annealing. This lamp-annealing device is provided with a means for the real-time measurement of the reflectivity or the transmissivity of the semiconductor film, and a means for evaluating the crystallinity of the semiconductor film by measuring the reflectivity or the transmissivity of the semiconductor film during, or before and after, the annealing process, and controlling the processing conditions, such as the intensity and the focus distance of the light projected by the light projection means, in accordance with the result of those measurements. By including a means for measuring the light reflected from or passed through the semiconductor film formed on a transparent substrate, it is possible to observe in real-time the crystallinity of the semiconductor film during the lamp-annealing process. Furthermore, by providing a means for controlling the processing conditions of the lamp anneal based on the measured crystallinity, it is possible to conduct feedback control while observing the crystallinity of the semiconductor film. Consequently, a lamp-annealing device is achieved with which a desired semiconductor film can be obtained.

The light measurement means detects light projected from the light projection means or light from a separately provided light source for evaluation.

It is preferable that a means for changing the relative position of the light projection means and the substrate is provided. This means continually or stepwise changes the relative position of the substrate and the light projection means while light from the light projection means is being irradiated onto the substrate to be annealed. In this case, it becomes unnecessary to simultaneously subject the entire substrate to anneal processing so that the entire substrate is included in the region irradiated by the light projection means. Moreover, it becomes possible to use a substrate with a large area. Because light is projected only to a single portion of the substrate, it also becomes possible to measure the crystallinity of the semiconductor film of the annealed portion and to reflect those results with respect to unprocessed portions of the same substrate. For example, a test portion can be provided on one end of the substrate, and based on the evaluation results of the crystallinity of this portion after it has been processed, more appropriate processing conditions can be set, and other portions of the substrate can be annealed using those settings.

Disposing a plurality of elements two-dimensionally in numerous locations to serve as a means for measuring reflected light or transmitted light makes it possible to measure the distribution of the crystallinity of the semiconductor film within the substrate plane during the annealing process. Consequently, those results can be used to control annealing conditions. For example, the condition of the anneal in each of the regions is evaluated and the results fed back into the processing conditions, thus making it possible to uniformly anneal the semiconductor film in regions within the same substrate.

When the wavelength components of 400 to 500 nm of the spectrum of light reflected or transmitted by the semiconductor film, which show most noticeable change according to the crystallinity of the polycrystalline silicon film, are spectrally analyzed, the crystallinity can be evaluated with a high degree of precision. Furthermore, it is possible to evaluate the crystallinity, without performing spectral analysis, by measuring the illumination of these wavelength range components. Therefore, it is preferable that the light measurement means detects light of a wavelength within a region of 400 to 500 nm.

The light irradiation control means controls the output of the light irradiation means, for example, based on the crystallinity results obtained from measuring reflected or transmitted light. When it is determined that the semiconductor film has been modified from an amorphous state into a polycrystalline state, the intensity of the light irradiated onto that region is decreased while on the other hand the intensity of light irradiated onto non-crystalline portions is increased, thus making it possible to reliably and uniformly perform the anneal.

There is also a method for controlling the focus distance of the lamp based on the evaluation results of the crystallinity of the semiconductor film. In lamps such as UV lamps, in which the lamp light is temporarily unstable when its output is changed, altering the focus distance allows for more precise processing than controlling the lamp output.

In devices including a means for changing the relative position of the lamp and the substrate, a method for controlling the speed of the relative shift of the lamp and substrate based on the evaluation results of the crystallinity is also useful. With shifting lamp-annealing devices for processing substrates with large areas, lamp anneals can be conducted while the crystallinity is confirmed.

A halogen lamp, for example, can be used as the light source of the aforementioned light projection means. Halogen lamps are capable of selectively heating a semiconductor film, because they have a broad spectrum with a wavelength peak at about 1 μm, their light has few components of a wavelength greater than approximately 3 μm, for which the absorption rate of the glass substrates is high, and have mainly components from near infrared to ultraviolet. Halogen lamps also have the advantage of excellent stability.

UV lamps and excimer lamps, both of which are capable of excellent selective heating, can also be used as the light projection means. UV lamps, such as metal halide lamps or xenon lamps, contain a large amount of near infrared to ultraviolet light in their irradiated light, which is absorbed by the polycrystalline silicon and amorphous silicon but not absorbed by the glass substrate, so the semiconductor film can be selectively heated. Moreover, although excimer lamps are inferior to UV lamps and halogen lamps in terms of intensity, when they are used as the light source, a certain film can be more selectively heated, because excimer lamps have a single luminance peak in a region from ultraviolet to vacuum ultraviolet (VUV) and illuminate only an extremely narrow region around that peak.

Although only for a mere instant, flash lamps such as xenon lamps flash with intense power, so when these lamps are used for the light source, the semiconductor film can be more selectively heated. In this case, the crystallinity of the semiconductor film is evaluated by measuring the reflected or transmitted light after the flash lamp is illuminated. If the semiconductor film is not yet crystallized, the flash lamp is illuminated again, and if it has been crystallized, the annealing process finishes there.

The lamp-annealing device of the present invention is used to activate impurities introduced into the semiconductor film. With the lamp-annealing device, the process of the semiconductor film changing from an amorphous state into a polycrystalline state can be measured in real-time during the annealing process, so that excessive annealing can be prevented. Additionally, the semiconductor film can be reliably activated with little variation within a single substrate and between substrates.

Furthermore, the processing state can be accurately evaluated by measuring the reflectivity or transmissivity of the semiconductor film during, or before and after, the annealing process and determining the crystallinity of the semiconductor film from those results. Thus, no shape changes in the substrate are caused by excessive heating, and it is possible to accurately proceed with the activation and crystallization. Furthermore, by controlling the annealing process based on the results of a measurement of the distribution of the reflectivity or transmissivity in the substrate plane, it is possible to uniformly activate and crystallize within the substrate plane

The substrate for a display element of the present invention includes a transparent substrate and switching elements made of thin film transistors formed thereon, and the refractive index in regions of the transparent substrate on which the switching elements are formed is less than the refraction index in other regions.

### BRIEF DESCRIPTION OF THE DRAWINGS

FIG. 1 is a schematic, longitudinal sectional view illustrating the primary elements of a lamp-annealing device in accordance with a embodiment of the present invention.

FIG. 2a, FIG. 2b, and FIG. 2c are schematic, longitudinal sectional views illustrating the primary elements of a substrate in the steps of a process for the manufacture of a polycrystalline silicon thin film transistor in that embodiment.

FIG. 3 is a schematic, longitudinal sectional view illustrating the primary elements of a lamp-annealing device according to another embodiment of the present invention.

FIG. 4a, FIG. 4b, FIG. 4c, and FIG. 4d are schematic, longitudinal sectional views illustrating the primary elements of a substrate in the steps of a process for the manufacture of a polycrystalline silicon thin film transistor in that embodiment.

FIG. 5 is a schematic, longitudinal sectional view illustrating the primary elements of a lamp-annealing device according to a further embodiment of the present invention.

FIG. 6a is a perspective view schematically illustrating the primary elements of a lamp-annealing device according to a further embodiment of the present invention, and FIG. 6b is a schematic, block diagram illustrating the configuration of that device.

FIG. 7a, FIG. 7b, and FIG. 7c are schematic, longitudinal sectional views illustrating the primary elements of a substrate in the steps of a process for the manufacture of a polycrystalline silicon thin film transistor in that embodiment.

FIG. 8a is a perspective view schematically illustrating the primary elements of a lamp-annealing device according to a further embodiment of the present invention, and FIG. 8b is a schematic, block diagram illustrating the configuration of that device.

FIG. 9 is a schematic, plan view illustrating the configuration of a substrate used in that embodiment.

FIG. 10a is a graph illustrating the relationship between optical wavelength and the reflectivity of the semiconductor film before and after the annealing process, and FIG. 10b is a graph illustrating the relationship between optical wavelength and the transmissivity of the semiconductor film before and after the annealing process.

FIG. 11a is a graph illustrating the transmissivity, reflectivity, and absorptivity of the glass substrate with respect to light of short wavelengths, and FIG. 11b is a graph illustrating the transmissivity of the glass substrate with respect to light of long wavelengths.

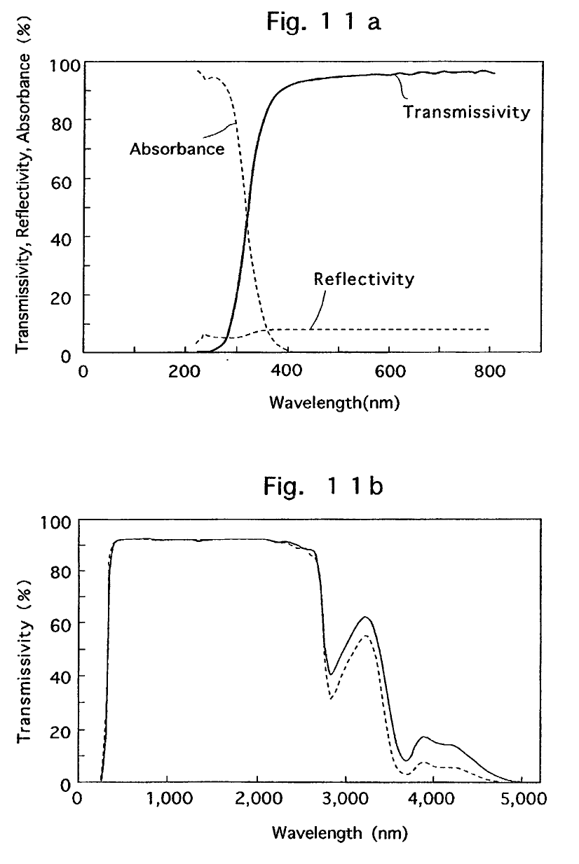

FIG. 12 is a diagram illustrating the diffraction of projected light in a lamp anneal using a light-shielding mask.

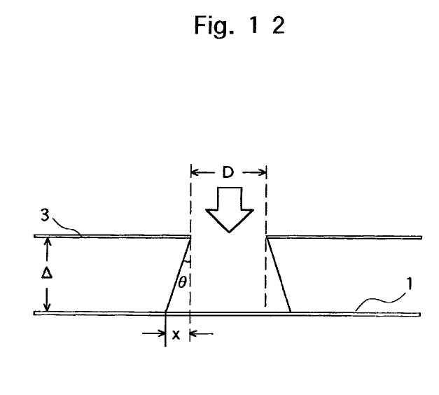

Explanation of the Numerals

| | |
|---|---|
| 1 | glass substrate |
| 1a | transistor formation region |
| 1b | test pattern |
| 2, 2a, 2b, 21, 22 | heating lamps |
| 3a, 3b | light-shielding masks |
| 4a, 4b | optical filters |
| 5a, 5b | casings |
| 6a, 6b | air inlets |
| 7a, 7b | air outlets |
| 8, 8a, 8b | reflectors |
| 10 | undercoat insulating film |
| 11 | polycrystalline silicon film |
| 11a | source region |
| 11b | drain region |
| 11c | low-concentration region |
| 12 | thermal oxide film |
| 13 | gate insulating film |
| 14 | gate electrode |
| 15 | source electrode |
| 16 | drain electrode |
| 17 | interlayer insulating film |
| 18 | resist layer |
| 19 | oxynitride film |
| 23, 23a, 23b | spectroscopes |
| 24a, 24b | light sources for evaluation |
| 25 | control portion |
| 25a | evaluation unit |
| 25b | control unit |
| 26 | pyrometer |

### BEST MODE FOR CARRYING OUT THE INVENTION

Preferred embodiments of the present invention are explained in detail below with reference to the drawings.

### Embodiment 1

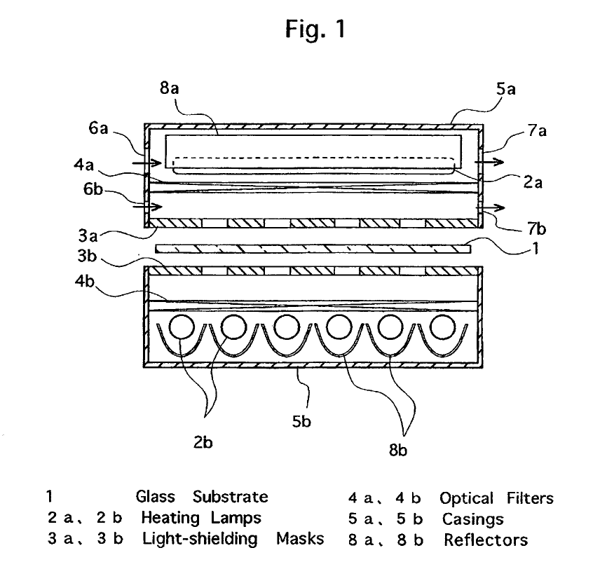

FIG. 1 schematically shows a lamp-annealing device of the present embodiment.

A plurality of heating lamps 2a are disposed parallel to one another and in a same plane above a glass substrate 1, on the surface of which a semiconductor film (not shown) to be annealed is formed. Light projected from the lamps 2a is irradiated by a reflector 8a toward the substrate 1 as substantially parallel light.

A light shielding mask 3a having a certain pattern and an optical filter 4a are disposed between the lamps 2a and the substrate 1. The light shielding mask 3a allows the light from the lamps 2a to irradiate only on certain regions of the substrate 1 surface. The optical filter 4a transmits only components of a specific wavelength range of the light from the lamps 2a. Consequently, light of a specific wavelength range is irradiated to certain regions of the substrate 1.

For example, the light shielding mask 3a has aperture portions having a pattern corresponding to the semiconductor film on the substrate 1, for example, and irradiates light from the lamps 2a only to regions of the substrate 1 where the semiconductor film is provided. The filter 4a transmits only light of a wavelength range of 350 nm to 2.5 μm. Because light of this wavelength range is only slightly absorbed by glass, it hardly heats the substrate 1 at all. If the semiconductor film formed on the substrate 1 is polycrystalline silicon, it is even more preferable that the filter 4a transmit only light of a wavelength range of 350 to 600 nm. Silicon demonstrates a high absorption rate of light with regard to light of this wavelength range, and thus the semiconductor film is effectively heated. Therefore, the semiconductor film can be selectively heated without heating other thin films or the like.

The lamps 2a, the light shielding mask 3a, and the filter 4a are contained in a casing 5a. The casing 5a is provided with air inlets 6a and 6b, and air outlets 7a and 7b, and the light shielding mask 3a and the filter 4a are cooled by circulating a gas with low reactivity, such as nitrogen, throughout the casing 5a as shown by the arrows in the diagram, preventing the light shielding mask 3a and the filter 4a are from changing shape and deteriorating in performance.

Below the substrate 1, a plurality of heating lamps 2b are provided parallel to one another and in the same plane. The lamps 2b irradiate light via a reflector 8b toward the surface of the other side of the substrate 1. The lamps 2b, like the lamps 2a, are for heating the semiconductor film on the substrate 1, and are also used for preliminarily heating the substrate 1. By this preliminary heating, the semiconductor film on the substrate 1 can be heated faster. For example, when the anneal is first initiated, light from the lamps 2b is uniformly irradiated toward the surface of the other side of the substrate 1 without using a light shielding mask 3b and an optical filter 4b. When preliminary heating is finished, the light shielding mask 3b and the optical filter 4b are inserted between the substrate 1 and the lamps 2b such that the semiconductor film is selectively heated from its rear surface. Although not shown in the drawings, a casing 5b containing the lamps 2b, the light shielding mask 3b, and the filter 4b, is provided with the same cooling unit as that in the casing 5a.

The atmosphere surrounding the substrate 1 is replaced with a gas such as nitrogen or oxygen if necessary.

A more specific example of the annealing process using the present lamp-annealing device is described below.

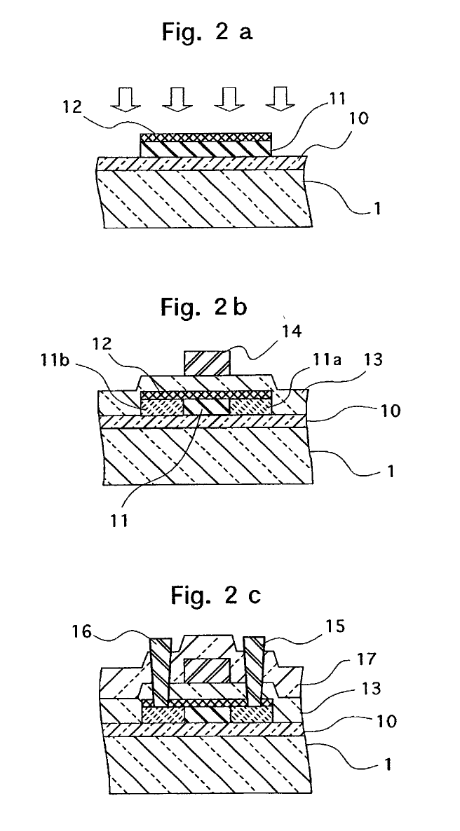

First, as shown in FIG. 2a, a SiO₂ film 2,000 to 4,000 Å thick is formed by plasma CVD as an undercoat insulating film 10 on the surface of the substrate 1 to prevent impurities from the substrate 1 from migrating to the semiconductor film to be formed. After an amorphous silicon layer of a 500 to 1,000 Å thickness is further formed on the undercoat insulating film 10 by CVD, that layer is crystallized by excimer laser anneal and a polycrystalline silicon film 11 of high quality is obtained.

The surface of the polycrystalline silicon film 11 thus formed on the substrate 1 is processed by annealing in an oxygen or an ozone atmosphere using the lamp-annealing device described above and at the same time thermally oxidized to form a thermal oxide film 12. Using UV lamps, such as metal halide lamps, for the lamps 2a and lamps 2b, the polycrystalline silicon film 11 is selectively heated from the upper surface, or both surfaces, of the glass substrate 1. It should be noted that in the present embodiment, the lamp anneal is performed before the polycrystalline silicon film 11 is patterned, so it is not absolutely necessary to use the light shielding masks 3a and 3b. Because the polycrystalline silicon film 11 formed on the glass substrate 1 absorbs all components of the light from the lamps 2a below a wavelength of 350 nm, which is absorbed by the glass substrate 1, a high cut filter that transmits only light of a wavelength at or below 2.5 μm is used for the filter 4a, such that light absorbed by the glass substrate 1 without being absorbed by the polycrystalline silicon film 11 is blocked.

On the other hand, light from the lamps 2b is irradiated on the polycrystalline silicon film 11 after passing through the glass substrate 1, so for the filter 4b, a band pass filter is used that blocks light of a wavelength shorter than the 350 nm, which is absorbed by the glass substrate 1, and further blocks light of a wavelength longer than 2.5 μm. Thus, while maintaining the temperature of the glass substrate 1 below 600° C., which is the softening point of the substrate 1, the polycrystalline silicon film 11 on the substrate 1 is temporarily heated to an elevated temperature of about 800° C., and as shown in FIG. 2a, a thermal oxide film 12 of a thickness or about several tens of Å is formed on the surface of the polycrystalline silicon film 11. This achieves an interface with few interface states between the polycrystalline silicon film 11 and the gate insulating film to be formed thereon, and attains a thin film transistor with excellent sub-threshold performance, carrier mobility, and so forth. Additionally, because the resulting thin film transistor has few interface states, it also has improved reliability against hot carriers.

After the lamp anneal, plasma CVD or atmospheric pressure CVD is used to form an SiO₂ film of a thickness of about 500 to 1,000 Å as a gate insulating film 13. Next, a layer made of tantalum, for example, is formed on the gate insulating film 13 at a thickness of 3,000 Å by sputtering, and this layer is processed with a certain pattern and a gate electrode 14 is obtained, as shown in FIG. 2b. After the gate electrode 14 has been formed, impurities imparting either n-type conduction or p-type conduction are added self-aligningly to the polycrystalline silicon film 11 by ion doping, forming a source region 11a and a drain region 11b.

Furthermore, after an SiO₂ film is formed over the gate insulating film 14 as an interlayer insulating film 17 using plasma CVD, contact holes are formed, into which a source electrode 15 and a drain electrode 16 are formed, and as shown in FIG. 2c, a polycrystalline silicon thin film transistor is completed.

### Embodiment 2

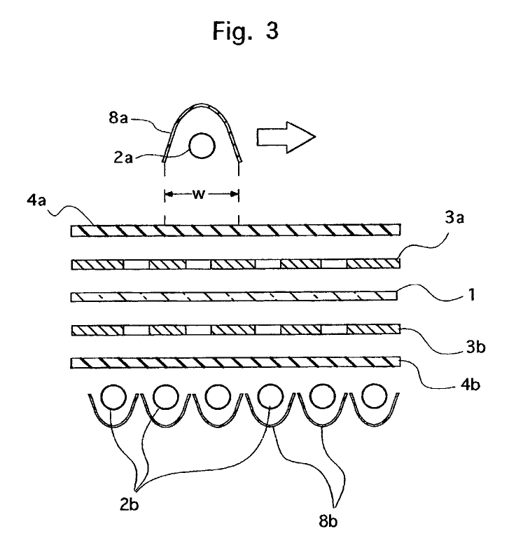

The configuration of a lamp-annealing device of the present embodiment is shown in FIG. 3. After collecting light projected from a lamp 2a, which is disposed above a glass substrate 1, a reflector 8a irradiates the light toward a region of about several millimeters in width on the substrate 1, which is indicated by the “W” in the drawing. Light projected from the lamp 2a passes through a filter 4a and a light shielding mask 3a, and is irradiated on the surface of the substrate 1. The lamp 2a and the reflector 8a are formed in one piece, and as shown by the arrow in the drawing, move from above one end portion of the substrate 1 to above the other end portion of the substrate 1. Consequently, since the lamp 2a and the substrate 1 move relative to one another, it is unnecessary to continuously irradiate lamp light onto the entire substrate 1, and thus the entire substrate surface can be annealed, even when a large substrate 1 is used, and the electricity required by the lamp 2a is also reduced. Here, when the substrate 1, the light shielding mask 3a, and the filter 4a are moved together while the lamp 2a is fixed, there is the danger that vibration during movement could change their relative positions, so it is preferable to move the lamp 2a with the substrate 1, the filter 4a, and the light shielding mask 3a being fixed.

Lamps 2b disposed below the substrate 1, like the lamps 2b used in the lamp-annealing device of the Embodiment 1, uniformly irradiate light over the entire surface of the substrate 1 via reflectors 8b. It should be noted that, if necessary, a light shielding mask 3b and a filter 4b which function like the light shielding mask 3a and the filter 4a, respectively, can be disposed on the side of the lamps 2b.

The following is an explanation of a specific example of an annealing process using this lamp-annealing device.

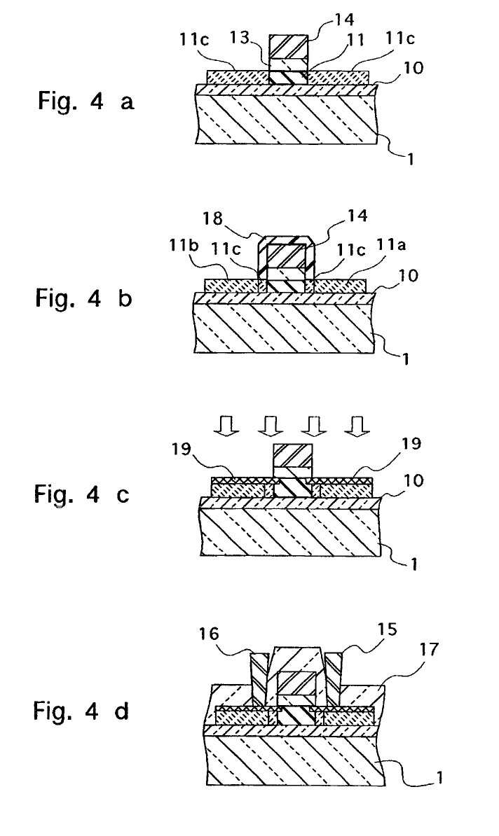

As shown in FIG. 4a, an undercoat insulating film 10 is formed on the glass substrate 1. Next, after an amorphous silicon layer is formed thereon, the amorphous silicon layer is crystallized by excimer laser anneal to obtain a polycrystalline silicon film 11. After the polycrystalline silicon film 11 has been processed into a predetermined shape, a SiO₂ film is formed on the polycrystalline silicon film 11 using plasma CVD. Tantalum is deposited on this SiO₂ film by sputtering, and then that layer is processed into a predetermined shape to form a gate electrode 14. Next, taking the gate electrode 14 formed on the upper surface as a mask, the SiO₂ film is processed with etching to form a gate insulator film 13. Then, taking the gate electrode 14 as a mask, the polycrystalline silicon film 11 is doped with an acceleration voltage of 5 to 15 kV to about 10¹³ to 10¹⁴/cm² with impurities such as phosphorous or boron to form a low-concentration region 11c in the polycrystalline silicon film 11, as shown in FIG. 4a. As shown in FIG. 4b, after a resist layer 18 is formed such that it covers the gate electrode 14 and the nearby low-concentration region 11c, the exposed portion of the low-concentration region 11c is doped, using an acceleration voltage of 5 to 15 kV, to about 5×10¹⁴ to 2×10¹⁵/cm² with the same impurity that was used when forming the low-concentration region 11c, to form a source region 11a and a drain region 11b, both with a high impurity concentration.

After the resist layer 18 is removed, the above-mentioned lamp-annealing device is used to anneal the polycrystalline silicon film 11. For example, using UV lamps such as metal halide lamps for the lamp 2a and lamps 2b, and using a band pass filter that transmits light of a wavelength range of 350 to 600 nm for the filter 4a, the lamp anneal is performed in a N₂O atmosphere. Additionally, for the light shielding masks 3a and 3b, masks are used that have been patterned such that the light from the lamps 2a and 2b is irradiated only onto the polycrystalline silicon film 11. Light projected from the lamps 2a and 2b is irradiated on both surfaces of the glass substrate 1, and with the glass substrate 1 being maintained at a temperature below its softening point, the polycrystalline silicon film 11 formed on the glass substrate 1 is heated to an elevated temperature of about 800° C. This heating recovers damage caused by the activation and doping of impurities added into the polycrystalline silicon film 11, and also oxynitrides both exposed surfaces of the polycrystalline silicon film 11, which becomes a channel portion. Furthermore, the heating improves the interface between the polycrystalline silicon film 11 and the gate insulating film 13. Here, because the nitrogen easily diffuses near the boundary portion between the low-concentration region 11c and the channel region via the gate insulating film 13, the polycrystalline silicon film 11 covered by the gate insulating film 13 is also exposed to oxynitridation to a depth of about several tens of Å from its surface, and an oxynitride film 19 is formed as shown in FIG. 4c. In this oxynitrided region, the vicinity of the interface between the polycrystalline silicon film 11 and the gate insulating film 13 becomes rich in nitrogen, and thus an extremely concentrated interface is formed there with a structure close to Si₃N₄ that has a high voltage resistance and is also strong against hot carriers. Additionally, due to the heating, both end portions of the gate insulating film 13 recover from the damage caused by doping, and the voltage resistance of the gate insulating film 13 improves.

As shown in FIG. 4d, after a layer made of SiO₂ is formed by plasma CVD as an interlayer insulating film 17, a contact hole is formed and a source electrode 15 and a drain electrode 16 are formed therein, thus completing a polycrystalline silicon thin film transistor.

The above-mentioned lamp anneal can also be performed after the interlayer insulating film 17 is formed.

### Embodiment 3

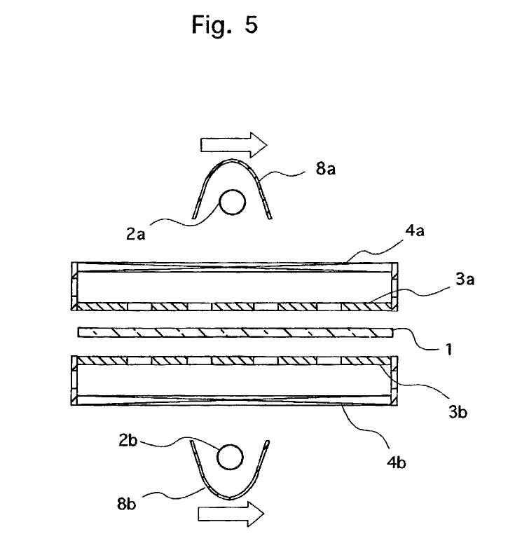

FIG. 5 schematically shows a lamp-annealing device of the present embodiment.

Light projected from a lamp 2a, which is disposed above a glass substrate 1, is collected by a reflector 8a, in the same way as that used in the lamp-annealing device of the Embodiment 2, and the light is transmitted through an optical filter 4a and a light-shielding mask 3a and irradiated onto the substrate 1. Light projected from a lamp 2b, which is disposed below the substrate 1, is also collected in a similar manner by a reflector 8b, transmitted through an optical filter 4b and a light-shielding mask 3b, and irradiated to the surface on the other side of the substrate 1. By simultaneously heating using a lamp above and a lamp below the substrate 1 in this way, the semiconductor film can be heated to an even higher temperature. For example, when the substrate 1 is a glass substrate and the semiconductor film is polycrystalline silicon, the filter 4a disposed above the substrate 1 transmits only light of a wavelength range at or below 2.5 μm, and the light-shielding mask 3a allows light to irradiate from the lamp 2a only onto regions of the substrate 1 where the semiconductor film is formed. The glass absorbs light of a wavelength at or below 350 nm, but here the semiconductor film formed on the glass substrate absorbs the light, so it does not reach the substrate 1. Thus the glass substrate is not heated, and only the semiconductor film is selectively heated. On the other hand, the filter 4b disposed below the substrate 1 transmits only components with a 350 to 600 nm wavelength of the light from the lamp 2b. The light-shielding mask 3b allows light to irradiate only onto the region formed with the semiconductor film.

Light of a wavelength shorter than 350 nm is absorbed by the glass substrate 1 and heats the glass substrate 1. Additionally, because the semiconductor film has a comparatively low absorption of light of a wavelength longer than 600 nm and because there is the danger that regions other than the semiconductor film could be irradiated by diffraction of this light after it is transmitted by the light-shielding mask 3b, it is desirable that a filter that transmits light of a wavelength of 350 to 600 nm be used for the filter 4b.

Thus, by irradiating light for annealing onto both sides of the substrate, the semiconductor film can be annealed at higher temperatures. Moreover, by irradiating lamp light onto the rear side of the substrate, the semiconductor film on regions shielded by a metallic film or the like from lamp light irradiated from the front side of the substrate can be directly heated.

Although not shown in the drawings, the lamp-annealing device of the present embodiment is also provided with a cooling means similar to that of the Embodiment 1.

Whether the semiconductor film was properly annealed while suppressing a rise in the temperature of the glass substrate can be ascertained, for example, by measuring the refractive index of the glass substrate. When the lamp-annealing device of the present invention is used for selective heating, the absorption of light by the glass substrate is almost entirely suppressed, so that a rise in the temperature of the substrate can be substantially regarded as resulting only from the transmission of heat from the semiconductor film. That is, the region of the substrate on which the semiconductor film is formed is exposed to higher temperatures than other regions. In lamp anneals, portions that rise in temperature during annealing are suddenly cooled, so that distortions easily develop in those portions. Consequently, according to the selective heating of the present invention, in regions on which the semiconductor film is formed the refractive index becomes lower than in other, non-heated regions.

Therefore, by measuring the refractive index of regions of the substrate on which a semiconductor film is formed and the refractive index of the other regions after the annealing process and by comparing those refractive indices with each other or with the refractive index of the substrate before the annealing process, it is possible to evaluate the extent of the selective heating. It is determined that the greater the difference in the refractive index between the region on which the semiconductor film is formed and the refractive index of other regions, the higher the temperature to which the semiconductor film was heated and the better the quality of the resulting semiconductor film.

With conventional lamp anneals it was either nearly impossible to evaluate the difference between the two because the entire substrate was heated to high temperatures, or the substrate of the regions on which a semiconductor film is formed dissipate heat only slowly, and thus instead of becoming lower, the refractive index increased in comparison to that of other regions. Moreover, also in anneals using an excimer laser or furnace, a difference in refractive index, such as when the lamp-annealing device of the present invention is used, cannot be ascertained.

### Embodiment 4

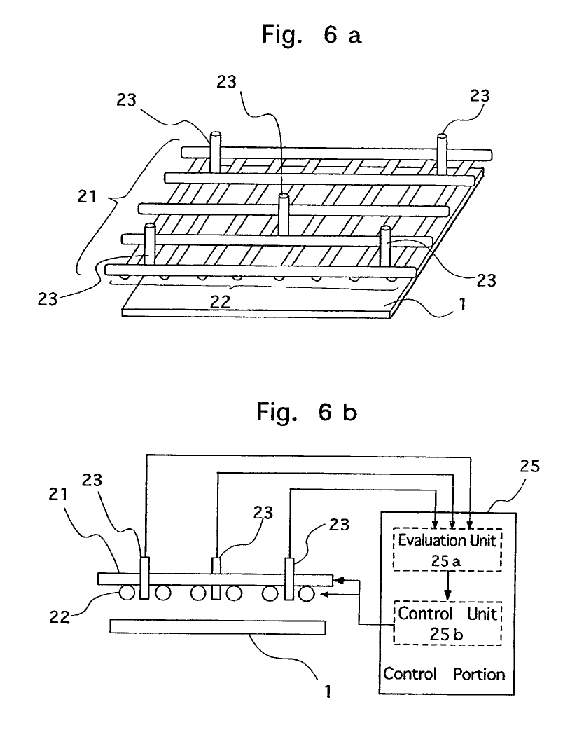

FIG. 6a and FIG. 6b show a lamp-annealing device of the present embodiment.

As shown in FIG. 6a, heating lamps 21 and 22 are disposed in a lattice arrangement in substantially the same plane. The surface of the glass substrate 1 on which the semiconductor film (not shown) to be annealed is formed is arranged in opposition to the lamps 21 and 22. Light emitted from the lamps 21 and lamps 22 is uniformly cast over the entire upper surface of the substrate 1, and the entire semiconductor film formed on the surface of the substrate 1 is heated all at once.

Spectroscopes 23 are provided in opposition to the side of the substrate 1 on which the semiconductor film is formed, and the spectroscopes detect light that has been emitted from the lamps 21 and 22 and reflected from the substrate 1 in the corner portions or center portion of the substrate 1. To measure transmitted light, the spectroscopes 23 are disposed in opposition to the other side of the substrate 1.

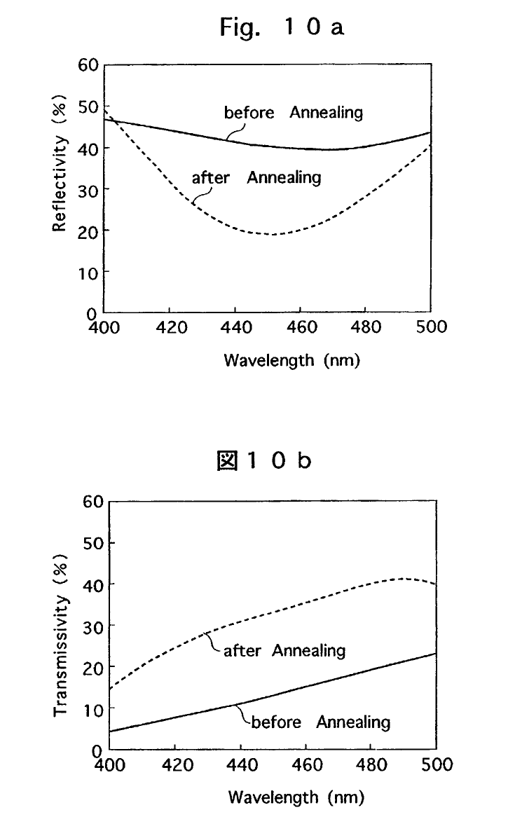

A portion of the light from the lamps 21 and 22 is either absorbed in the semiconductor film or passes through the substrate 1, and the remaining light returns to the side with the lamps 21 and 22 as reflected light. The spectra of reflected light and transmitted light are significantly altered depending on the crystallinity of the semiconductor film formed on the substrate 1. In particular, when the semiconductor film is silicon, the spectrum of a wavelength range of 400 to 500 nm is significantly altered when the crystallinity is changed, and thus it is possible to ascertain the crystallinity by evaluating the spectrum shape of this region, as is shown in FIG. 10a and FIG. 10b.

As shown in FIG. 6b, the spectroscopes 23 separate incident light, and output a signal to a control portion 25 regarding the spectrum of the wavelength range of 400 to 500 nm of that light. An evaluation unit 25a of the control portion 25 compares the signals from the spectroscopes 23 with each other or against a previously stored spectrum model, and evaluates the crystallinity of the semiconductor film in the regions in which the spectroscopes detected reflected light. A control unit 25b controls the respective outputs of the lamps 21 and 22 based on the crystallinity of the film obtained from the evaluation unit 25a. For example, in regions in which an amorphous state has changed into crystal, the output of the lamps 21 or 22 irradiating light on those regions is reduced or set to zero. Conversely, in regions that have not yet crystallized, the output of the corresponding lamps 21 or 22 is increased. Generally, with regard to the positioning of the lamps, the temperature at the center portion of the substrate 1 becomes lower than that at the end portions, which dissipate heat more easily. Consequently, the semiconductor film in the center portion crystallizes first. In such cases, the output of the lamps 21 and 22 on the center portion is either reduced or set to zero, and the output of the lamps 21 and 22 on the end portions is increased. When the semiconductor film of the end portions is crystallized, the output of all of the lamps 21 and 22 is reduced to zero. Thus, the semiconductor film formed in the center portion of the substrate 1 is not excessively heated, and the semiconductor film on the end portions can be sufficiently crystallized.

It is also possible to control the crystallization of the semiconductor film by changing the distance between the lamps and the substrate instead of controlling the output of the lamps. For example, a means for moving each of the lamps 21 and 22 shown in FIG. 6a upward and downward within the drawing is provided, and the control portion 25 controls the vertical movement of the lamps 21 and 22 instead of their output. That is, the control portion 25 raises and lowers the position of lamps 21 or 22 in accordance with portions where it is desirable to adjust the energy of the light irradiated onto the semiconductor film. If a UV lamp, such as a xenon lamp or a metal halide lamp, or an excimer lamp which require a long time to stabilize the intensity of their emitted light when changing the output, is used, then it is preferable to control the position of the lamps than to control the output of the lamps.

If a flash lamp, for example a xenon lamp, is used for the lamp, it is not controlled during the anneal, but after the flash lamp has been lit, the crystallinity is evaluated and if the semiconductor film is not yet crystallized the flash lamp is illuminated once again. By finishing the lamp annealing process when the semiconductor film is entirely crystallized, the semiconductor film can be reliably crystallized. However, in this case it is necessary to measure the reflected light or transmitted light when the lamps are not lit and evaluate the crystallinity, and thus in addition to the heating lamps it is necessary to provide light sources, such see a white-light source or a He-Ne light source, to provide light for evaluating that crystallinity, which have to be arranged for the respective spectroscopes such that the reflected light or transmitted light enters the spectroscopes.

It should be noted that it is not always necessary to prepare a plurality of spectroscopes for measuring reflected light and to dispose them two-dimensionally. For example, spectroscopes can be disposed only in positions corresponding to the end portions of the substrate, where the temperature becomes the lowest, and all of the lamps are turned off when the spectrum of light entering those spectroscopes is that of a semiconductor film that has been crystallized, thus finishing the annealing process. Thus, the semiconductor film is not excessively heated, and moreover the semiconductor film can be accurately crystallized.

The following is a description of a more specific example of the annealing process using this lamp-annealing device.

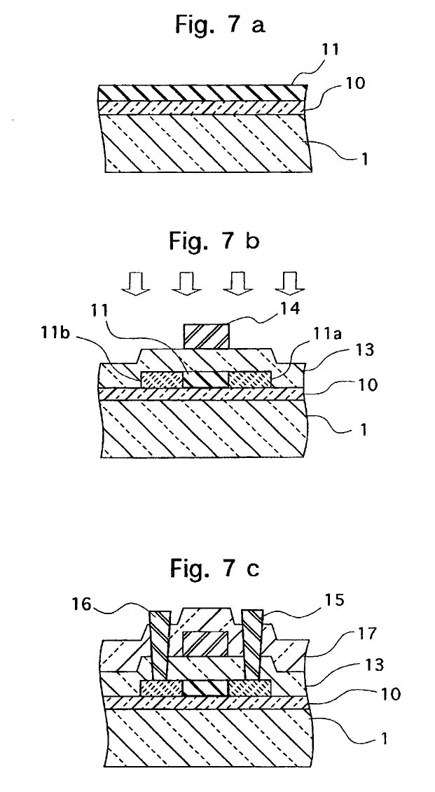

First, as shown in FIG. 7a, a SiO₂ film of 2,000 to 4,000 Å thickness is formed on the substrate 1 with CVD as an undercoat insulating film 10 for preventing impurities in the substrate 1 from migrating into the semiconductor film that is to be formed on the surface of the substrate 1. Next, after an amorphous silicon layer is formed thereon at a thickness of 500 to 1,000 Å by CVD, that layer is crystallized with excimer laser anneal to obtain a polycrystalline silicon film 11 of high quality. After the obtained polycrystalline silicon film 11 is patterned into a desired shape, a SiO₂ film of a thickness of approximately 1,000 Å is formed as a gate insulating film 13 ZIP, on the polycrystalline silicon film 11 by CVD. Next, after a 2,000 Å thick layer made of tantalum for example, is formed by sputtering, that layer is processed into a predetermined pattern to form a gate electrode 14 After the gate electrode 14 is formed, the polycrystalline silicon film 11 is doped with impurities such as phosphorous or boron, and as shown in FIG. 7b, a source region 11a and a drain region 11b are formed in the polycrystalline silicon film 11 by self-alignment.

Next, using the aforementioned lamp-annealing device, the impurities that were injected into the source region 11a and the drain region 11b are activated. The activation process is for shifting injected impurities to the sites of the silicon and for releasing the carriers, and it is also for crystallizing the polycrystalline silicon made non-crystalline by the doping.

For example, metal halide lamps as the lamps 21 and 22 are lit with an output of 6 kW per lamp, and irradiate light in the direction indicated by the arrows in FIG. 7b. At this time, while the two-dimensionally arranged spectroscopes 23 measure the crystallinity of the polycrystalline silicon film 11 formed on the substrate 1, the output of the lamps 21 and 22 or the distance of the each of the lamps from the substrate 1 is controlled in accordance with the change of the crystallinity.

After the activation process is over, a SiO₂ film is formed as an interlayer insulating film 17 by CVD. Next, contact holes are formed, into which a source electrode 15 and a drain electrode 16 are disposed, and a polycrystalline silicon thin film transistor as shown in FIG. 7c is completed.

### Embodiment 5

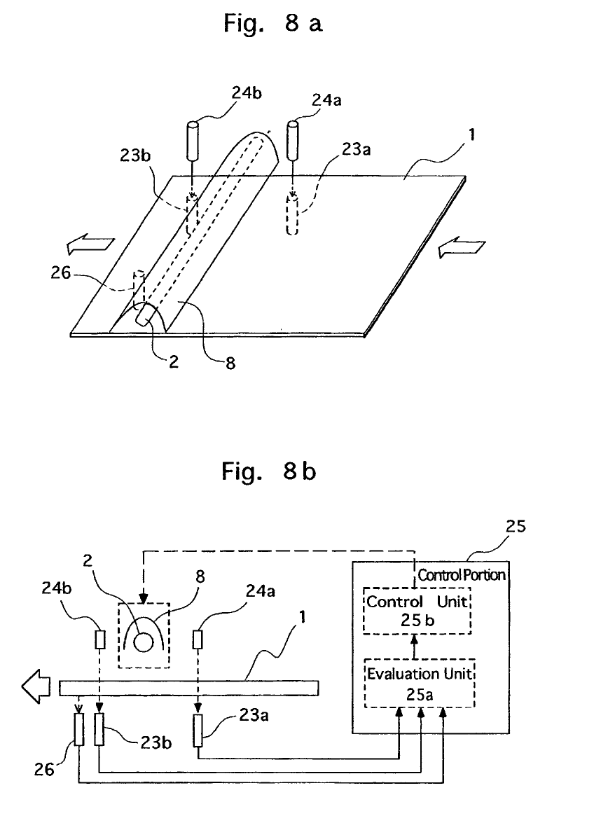

FIG. 8a and FIG. 8b show a lamp-annealing device of the present embodiment.

A lamp 2, for example a halogen lamp, for heating a semiconductor film, projects light for heating across the entire width of a glass substrate 1 provided with a semiconductor film (not shown) that is to be processed A reflector 8 collects light from the lamp 2 and emits that light toward the substrate 1. The substrate 1 is transported in the direction of the arrows in the drawing by a transporting means (not shown). Consequently, as the substrate 1 is transported, the semiconductor film of the region on the substrate 1 that is passed below the lamp 2 in the drawing undergoes anneal processing. An evaluation light source 24a emits white light or a He-Ne light toward regions of the substrate 1 not yet annealed. A spectroscope 23a detects those components of the light from the light source 24a that have been transmitted by the substrate 1. An evaluation light source 24b emits white light or He-Ne light toward regions of the substrate 1 that have been annealed, and a spectroscope 23b detects those components of the light from the light source 24b that have been transmitted through the substrate 1.

A control portion 25 evaluates in real-time the crystallinity of the semiconductor film based on signals from the spectroscopes 23a and 23b. For example, the control portion 25 evaluates the change in the crystalline properties of the semiconductor film resulting from annealing based on both of these signals. Moreover, the control portion 25 evaluates the crystallinity of the semiconductor film after the film has been annealed by comparing signals from the spectroscope 23b with a previously recorded model.

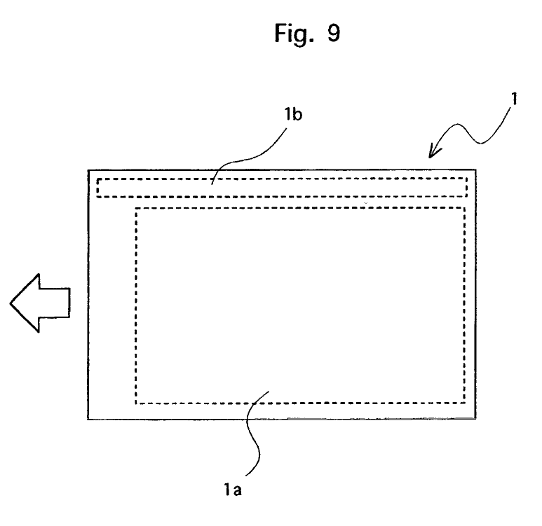

As shown in FIG. 9, the semiconductor film for checking the extent of the anneal on the substrate 1 is provided with a test pattern 1b, which is consecutively provided in the transport direction of the substrate 1 shown by the arrow in the drawing. The spectroscopes 23a and 23b each detect light that has passed through the test pattern 1b. When the substrate 1 is transported in the direction of the arrow in the drawing, the end portions of the test pattern 1b undergo anneal processing ahead of a transistor formation region 1a, which is for forming thin film transistors on the substrate 1. Consequently, before anneal processing is performed on the transistor formation region 1a, annealing conditions are optimized in accordance with signals from the spectroscope 23b relating to the light transmitted through the annealed test pattern 1b. If the crystallinity of the semiconductor film is evaluated as insufficient after the annealing process based on signals from the spectroscope 23b, the control portion 25 continues the annealing process with the same annealing conditions, and if the semiconductor film is improperly crystallized, the control portion 25 increases the speed of crystallization for example by adjusting the position of the substrate 1, the lamp 2, or the reflector 8 such that the output of the lamp 2 increases, the shifting speed of the substrate 1 is slowed down, or the region of the substrate 1 that is irradiated with light is reduced and the energy of the light irradiated on the semiconductor film is increased. In the same way, the test pattern 1b is evaluated while the transistor formation region 1a is being annealed, and those evaluation results are fed back into the annealing conditions. For example, when it is determined during the annealing process that the crystallization of the transistor formation region 1a is insufficient, the substrate 1, for example, is moved in the opposite direction and reannealed.

A pyrometer 26 measures the temperature of the substrate 1 after the substrate 1 has been annealed, and outputs a signal relating to that obtained temperature to the control portion 25. If the temperature of the substrate 1 is at least 650° C., for example, the control portion 25 determines that the processing conditions are excessive and feeds this information back into the annealing conditions. That is, by adjusting the lamp output, shifting speed, and the distance between the lamp and substrate, for example, excessive anneal processing is prevented.

### Industrial Applicability

According to the present invention, because a temperature increase in the substrate is inhibited and the semiconductor film can be selectively heated, it is possible to anneal the semiconductor film at elevated temperatures without causing shape changes in the substrate. Moreover, because the lamp anneal processing can be performed under optimal conditions, the semiconductor film is activated and crystallized properly and with a high degree of uniformity without causing any shape changes in the substrate. Therefore, the present invention provides a lamp-annealing device with which thin film transistors can be manufactured with excellent performance and reliability, and thereby significantly contributes to an improvement in performance and reliability of the thin film transistors.

1. A lamp-annealing device for annealing a semiconductor film formed on a substrate, comprising:
a light projection means for projecting light for heating toward a transparent substrate; and
a selective heating means, disposed between the transparent substrate and the light projection means, for selectively heating a certain region on the transparent substrate

2. The lamp-annealing device according to claim 1, wherein the selective irradiation means is a light-shielding mask that irradiates light projected from the light projection means only onto the certain region on the transparent substrate.

3. The lamp-annealing device according to claim 2, wherein the semiconductor film is formed only on the certain region.

4. The lamp-annealing device according to claim 2, wherein the light-shielding mask has a pattern of aperture portions with a minimum width of 5 to 100 μm.

5. The lamp-annealing device according to claim 2, wherein the transparent substrate and the light-shielding mask are disposed at a spacing of 0.1 to 10 mm.

6. The lamp-annealing device according to claim 1, wherein the selective irradiating means is an optical filter that transmits only certain wavelength components of the light projected from the light projection means.

7. The lamp-annealing device according to claim 6, wherein the optical filter is a low pass filter that blocks light of a wavelength longer than a certain value, wherein that certain value is at least 2.5 μm.

8. The lamp-annealing device according to claim 6, wherein the optical filter is a low pass filter that blocks light of a wavelength longer than a certain value, wherein that certain value is at least 700 nm.

9. The lamp-annealing device according to claim 6, wherein the optical filter is a high pass filter that blocks light of a wavelength shorter than a certain value, wherein that certain value is at most 350 nm.

10. The lamp-annealing device according to claim 6, wherein the optical filter is a high pass filter that blocks light of a wavelength shorter than a certain value, and wherein light of a wavelength that raises the energy states of the material configuring the transparent substrate is blocked.

11. The lamp-annealing device according to claim 6, wherein the optical filter is made of the same material as the transparent substrate.

12. The lamp-annealing device according to claim 6, wherein the optical filter is a band pass filter that passes light of a wavelength of 350 to 700 nm

13. The lamp-annealing device according to claim 6, wherein the optical filter is a band pass filter that passes light of a wavelength of 350 nm to 2.5 μm.

14. The lamp-annealing device according to claim 6, further comprising a light-shielding mask provided between the light projection means and the transparent substrate, which allows light projected by the light projection means to irradiate only certain regions of the transparent substrate.

15. The lamp-annealing device according to claim 1, wherein the light projection means is disposed in opposition to each of a pair of primary surfaces of the transparent substrate, and wherein the selective heating means is disposed on at least one side thereof.

16. The lamp-annealing device according to claim 1, further comprising a displacement means for changing a relative position of the light projection means and the transparent substrate, and wherein the light projection means irradiates light only onto a limited region on the transparent substrate.

17. The lamp-annealing device according to claim 16, wherein a position of the transparent substrate and that of the selective heating means are fixed, and wherein the displacement means shifts the light projection means.

18. The lamp-annealing device according to claim 1, further comprising a cooling unit for inhibiting temperature increases in the selective heating means.

19. A lamp-annealing device for annealing a semiconductor film formed on a substrate, comprising:
a light projection means for projecting light toward a semiconductor film formed on a transparent substrate, in order to heat the semiconductor film;
a light measurement means for measuring light of a certain wavelength that is transmitted by the semiconductor film and the transparent substrate or reflected by the semiconductor film;
a crystal evaluation means for evaluating the crystallinity of the semiconductor film based on measurement results obtained by the light measurement means; and
a light irradiation control means for controlling the processing conditions of the semiconductor film based on the evaluation results from the crystal evaluation means.

20. The lamp-annealing device according to claim 19, wherein the light measurement means detects light projected from the light projection means.

21. The lamp-annealing device according to claim 19, further comprising an evaluation light source for projecting light to be received by the light measurement means toward the semiconductor film.

22. The lamp-annealing device according to claim 19, further comprising a displacement means for changing the relative position of the light projection means and the transparent substrate, wherein the light projection means irradiates light only onto a limited region of the transparent substrate.

23. The lamp-annealing device according to claim 19, wherein the light measurement means includes a plurality of light detection elements disposed in substantially the same plane.

24. The lamp-annealing device according to claim 19, wherein the light measurement means detects light of a wavelength range of 400 to 500 nm.

25. The lamp-annealing device according to claim 19, wherein the light irradiation control means controls an output of light irradiated by the light projection means based on the evaluation results.

26. The lamp-annealing device according to claim 19, further comprising a focus distance displacement means for controlling a focus distance of light projected from the light projection means toward the transparent substrate, wherein the light irradiation control means operates the focus distance displacement means based on the evaluation results.

27. The lamp-annealing device according to claim 22, wherein the light irradiation control means operates the displacement means based on the evaluation results, and changes the relative speed of the transparent substrate and the light projection means.

28. The lamp-annealing device according to claim 19, wherein a light source of the light projection means is selected from the group consisting of a halogen lamp, an excimer lamp, and a flash lamp.

29. The lamp-annealing device according to claim 19, wherein a light source of the light projection means is a UV lamp selected from the group consisting of a high-pressure mercury lamp, a metal halide lamp, and a xenon lamp.

30. A substrate for a display element, comprising a transparent substrate and switching elements made of thin film transistors formed on the transparent substrate, wherein the refractive index in a region of the transparent substrate on which the switching elements are formed is smaller than the refractive index in other regions.
